(19) United States
(12) Patent Application Publication
(10) Pub. No.: US 2025/0316156 A1
(43) Pub. Date: Oct. 9, 2025

(54) DOOR LOCK ASSEMBLY AND ELECTRICAL APPARATUS

(71) Applicant: ILLINOIS TOOL WORKS INC., Glenview, IL (US)

(72) Inventors: Dongxuan WANG, Dongguan City (CN); Sangui Wu, Dongguan City (CN)

(73) Assignee: ILLINOIS TOOL WORKS INC., Glenview, IL (US)

(21) Appl. No.: 19/098,647

(22) Filed: Apr. 2, 2025

(30) Foreign Application Priority Data
Apr. 3, 2024 (CN) 202410400585X

(51) Int. Cl. G08B 21/18; E05C 3/00

(52) U.S. Cl. CPC G08B 21/18; E05C 3/006

(57) ABSTRACT

A door lock assembly for locking a door of an electrical apparatus including a movable component and a door status signal assembly. The movable component reciprocates in opposite first and second directions and has a side surface in a length direction and is provided with a triggering structure on the side surface. The door status signal assembly is arranged toward the side surface of the movable component and configured to generate a door status indication signal. The triggering structure is configured to activate the door status signal assembly during the reciprocating movement of the movable component, so that the door status signal assembly generates a door status indication signal. The door status signal assembly of the door lock assembly is arranged toward the side surface of a rotating wheel seat in the length direction, so that the door lock assembly has a smaller dimension in a width or thickness direction.

### CROSS-REFERENCE TO RELATED APPLICATIONS

Chinese Patent Application No. CN 202410400585X, filed on 3 Apr. 2024, the priority document corresponding to this invention, to which a foreign priority benefit is claimed to each under Title 35, United States Code, Section 119, and their entire teachings are incorporated, by reference, into this specification.

### BACKGROUND OF THE INVENTION

### Field of the Invention

The present disclosure relates to a door lock assembly and an electric apparatus, in particular to a door lock assembly with a compact structure, and an electric apparatus using the door lock assembly.

### Discussion of Related Art

In some commercial or household electrical apparatuses, a door lock assembly may be used for locking or opening doors of the electrical apparatuses (such as a dryer, a washing machine and a dishwasher). The door lock assembly is generally used in cooperation with a door status signal device to indicate the status of the door (such as an open status and a closed status).

### SUMMARY OF THE INVENTION

In view of the need for a compact structure, a door lock assembly and a door status signal device are typically integrated in a door lock box, and such a door lock box can be designed to have a low profile structure for mounting on an electrical apparatus, and can be adapted to different mounting orientations of a door.

In order to meet the above need for a door lock assembly, according to a first aspect, the present disclosure provides a door lock assembly for locking a door of an electrical apparatus, the door lock assembly including a movable component and a door status signal assembly; the movable component is configured to reciprocate in a first direction and a second direction, where the first direction is opposite to the second direction, the movable component has a side surface in a length direction, the movable component is provided with a triggering structure on the side surface, and the door status signal assembly is arranged toward the side surface of the movable component and configured to generate a door status indication signal; where the triggering structure is configured to activate the door status signal assembly during the reciprocating movement of the movable component, so that the door status signal assembly generates the door status indication signal.

According to the first aspect of the disclosure, the movable component has a first position and a second position in a movement stroke of the movable component, and the movable component is configured to reciprocate between the first position and the second position in the first direction and the second direction.

According to the first aspect of the disclosure, the movable component is configured to be movable under actuation of a door hook of the door, where the door hook is movable in the first direction or the second direction to drive the movable component to move in the first direction or the second direction.

According to the first aspect of the disclosure, the door lock assembly is provided with a door hook receiving hole, the door hook receiving hole being configured to accommodate the door hook; where the door hook is configured to actuate the movable component to move in the first direction when the door hook is inserted into the door hook receiving hole; and where the door hook is configured to actuate the movable component to move towards the second direction when the door hook is pulled out from the door hook receiving hole.

According to the first aspect of the disclosure, the movable component is in the first position when the door hook is completely inserted into the door hook receiving hole; and the movable component is in the second position when the door hook is completely pulled out from the door hook receiving hole.

According to the first aspect of the disclosure, the triggering structure is provided with a step structure, the step structure including a step protruding portion and a step recessing portion; the door status signal assembly includes a switch, the switch being provided with a switch protruding structure, and the switch protruding structure being arranged toward the step structure; where the step protruding portion is in contact with the switch protruding structure when the step protruding portion of the step structure moves to a position coinciding with the switch protruding structure of the switch during the reciprocating movement of the movable component in the first direction and the second direction, such that the door status signal assembly generates a first door status signal of the door; and the step protruding portion disengages from the switch protruding structure when the step recessing portion of the step structure moves to a position coinciding with the switch protruding structure of the switch, such that the door status signal assembly generates a second door status signal of the door.

According to the first aspect of the disclosure, the first door status signal indicates a closed status of the door, and the second door status signal indicates an unclosed status of the door, or the first door status signal indicates an unclosed status of the door, and the second door status signal indicates a closed status of the door.

According to the first aspect of the disclosure, the door status signal assembly further includes a circuit board, the switch being mounted on the circuit board, and the switch protruding structure of the switch being disposed to extend out of the circuit board toward the triggering structure of the movable component; where the circuit board is provided with a circuit for generating the first door status signal and the second door status signal.

According to the first aspect of the disclosure, the circuit board is fixedly mounted on the door lock assembly.

According to the first aspect of the disclosure, the first position corresponds to a closed position of the door, and the second position corresponds to an unclosed position of the door.

According to the first aspect of the present disclosure, the door lock assembly further includes: a rotating wheel provided with a rotating wheel rotating shaft, the rotating wheel rotating shaft being rotatably mounted on the movable component, such that the rotating wheel is rotatable on the movable component in a first rotational direction or a second rotational direction; where a direction in which the rotating wheel rotating shaft extends is perpendicular or substantially perpendicular to the first direction or the second direction.

According to the first aspect of the present disclosure, the door lock assembly further includes: a housing and a pin shaft, where the movable component and the rotating wheel are configured to be movably accommodated within the housing, the pin shaft being fixedly mounted on the housing; where the rotating wheel has a rotating wheel abutting side, and the rotating wheel abutting side is configured to abut against the pin shaft, so that the rotating wheel rotating shaft is movable in the first direction or the second direction under the abutting action when the rotating wheel rotates in the first rotational direction or the second rotational direction in the movable component, so as to drive the movable component to move in the housing in the first direction or the second direction.

According to the first aspect of the disclosure, the door hook receiving hole is formed on a surface of the housing, and the door hook is configured to be movable through the door hook receiving hole so as to be inserted into the housing; where the rotating wheel is driven to rotate in the first rotational direction or the second rotational direction about the rotating wheel rotating shaft when the door hook is inserted into or pulled out from the door hook receiving hole, so as to drive the movable component to move in the first direction or the second direction in the housing.

According to the first aspect of the disclosure, the rotating wheel is further provided with a rotating wheel lock hook, the rotating wheel lock hook being arranged on an opposite side of the rotating wheel with respect to the rotating wheel abutting side;
where the door hook is configured to be able to abut against and engage with the rotating wheel lock hook when the door hook is inserted into the door hook receiving hole, so as to drive the rotating wheel to rotate in the first rotational direction, and the rotating wheel is capable of rotating in the first rotational direction to drive the movable component to move in the housing in the first direction under the abutting action between the rotating wheel abutting side and the pin shaft; and
where the door hook is gradually disengaged from the rotating wheel lock hook and drives the rotating wheel to rotate in the second rotational direction when the door hook is pulled out from the door hook receiving hole, and the rotating wheel is capable of rotating in the second rotational direction to drive the movable component to move in the housing in the second direction under the abutting action between the rotating wheel abutting side and the pin shaft.

According to the first aspect of the present disclosure, the door lock assembly further includes: at least one bias spring abutted between the housing and the movable component so as to provide a biasing force for the movable component to move towards the first direction; where the at least one bias spring is configured to store biasing potential energy during the movement of the movable component towards the second direction.

According to the first aspect of the disclosure, the movable component is a rotating wheel seat, the rotating wheel seat is internally provided with at least one bias spring accommodating cavity for accommodating the at least one bias spring; and a bias spring abutting surface is provided at an inner side of the housing for abutting against the at least one bias spring, so that the at least one bias spring is abutted between the bias spring abutting surface and an accommodating cavity abutting wall of the at least one bias spring accommodating cavity.

According to the first aspect of the disclosure, the rotating wheel also has a rotating wheel retaining side, the rotating wheel retaining side being configured to be able to abut against the pin shaft such that the rotating wheel is able to remain stable without movement relative to the housing when not actuated by the door hook; where the rotating wheel retaining side is adjacent to the rotating wheel abutting side, and the rotating wheel is rotated to a position such that the rotating wheel retaining side abuts against the pin shaft when the movable component moves to the second position.

According to a second aspect, the present disclosure provides an electrical appliance, including a door lock assembly as described in the first aspect of the present disclosure.

Some of the additional aspects and advantages of the disclosure will be set forth in the following description, and some will become apparent from the following description, or be learned by practice of the disclosure.

### BRIEF DESCRIPTION OF SEVERAL VIEWS OF THE DRAWINGS

FIG. 1A is a perspective view of a door lock assembly of the present disclosure, with a door hook in a non-inserted status.

FIG. 1B is a perspective view of the door lock assembly with a housing concealed shown in FIG. 1A to show more components inside the housing.

FIG. 1C is a perspective view of the door lock assembly shown in FIG. 1B after the door hook is inserted.

FIG. 1D is a perspective view of the door lock assembly of the present disclosure from a bottom perspective.

FIG. 1E is a perspective view of the door lock assembly with some components shown in FIG. 1D concealed to clearly illustrate an assembly relationship between a pin shaft and a housing and a cooperation relationship between the pin shaft and a rotating wheel.

FIG. 1F is an exploded view of the door lock assembly of the present disclosure.

FIG. 2A is a side view of a door lock assembly of the present disclosure in an unclosed status.

FIG. 2B is a cross-sectional view of FIG. 2A taken along sectional line A-A.

FIG. 2C is a partial enlarged view B of FIG. 2B.

FIG. 2D is a side view of the door lock assembly of the present disclosure in a closed status.

FIG. 2E is a cross-sectional view of FIG. 2D taken along sectional line C-C.

FIG. 2F is a partial enlarged view D of FIG. 2E.

FIG. 3 is a side view of the rotating wheel.

FIG. 4A is an interior side view when the door hook is inserted into a door hook receiving hole and just comes into contact with the rotating wheel.

FIG. 4B is an interior view of the door hook in an inserted status shown in FIG. 4A from another perspective.

FIG. 5A is an interior side view of the door hook inserted into the door hook receiving hole by a first depth.

FIG. 5B is an interior view of the door hook in an inserted status shown in FIG. 5A from another perspective.

FIG. 6A is an interior side view of the door hook inserted into the door hook receiving hole by a second depth.

FIG. 6B is an interior view of the door hook in an inserted status shown in FIG. 6A from another perspective.

FIG. 7A is an interior side view of the door hook fully inserted into the door hook receiving hole.

FIG. 7B is an interior view of the door hook in an inserted status shown in FIG. 7A from another perspective.

FIG. 8 is an interior side view of the door hook completely pulled out from the door hook receiving hole.

FIG. 9 is a schematic diagram of an electrical apparatus using a door lock assembly of the present disclosure in a door open position.

### DESCRIPTION OF PREFERRED EMBODIMENTS

Various specific embodiments of the disclosure will be described below with reference to the accompanying drawings which form part of the disclosure, but the embodiments do not limit the disclosure. It should be understood that although the terms such as “upper”, “lower”, “left”, “right”, “front”, “rear” and the like indicating directions are used in the disclosure to describe orientations of various illustrative structural parts and elements in the disclosure, the terms used herein are merely used for ease of illustration and are determined based on the illustrative orientation shown in the accompanying drawings. Since the embodiments of the present disclosure can be arranged in different orientations, the terms indicating directions are merely illustrative and should not be considered as limitations.

The term “comprise/include” and derivatives thereof mean inclusion without limitation. Unless otherwise specified and limited, the terms “mounting”, “connecting” and “connection” should be understood broadly. For example, they may be a mechanical or electrical connection, internal communication between two elements, or a direct connection or indirect connection via an intermediate medium. For those of ordinary skills in the art, the specific meanings of the above terms can be understood according to specific cases. If possible, the same or similar reference numerals used in the present disclosure refer to the same components.

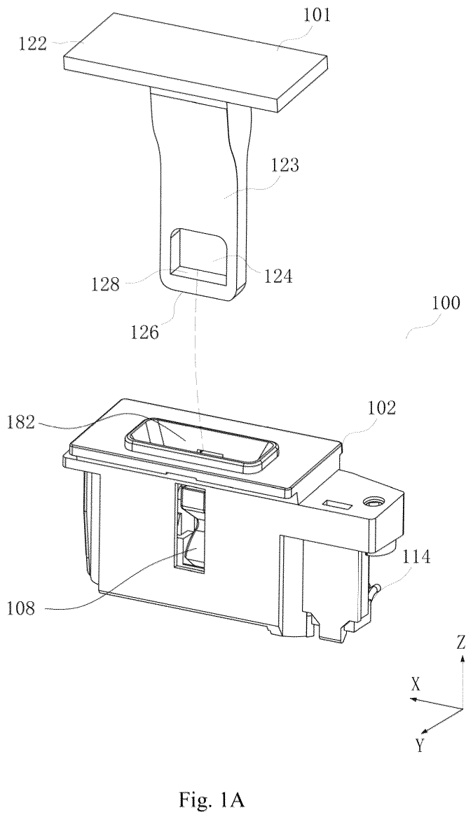

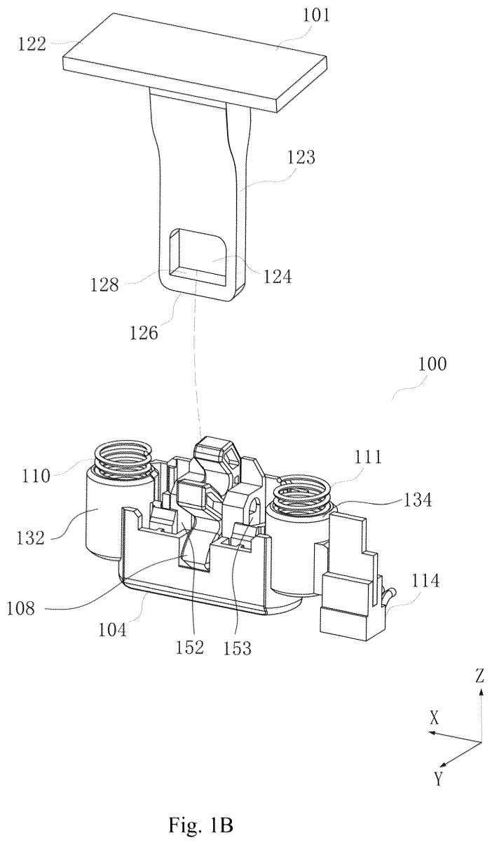

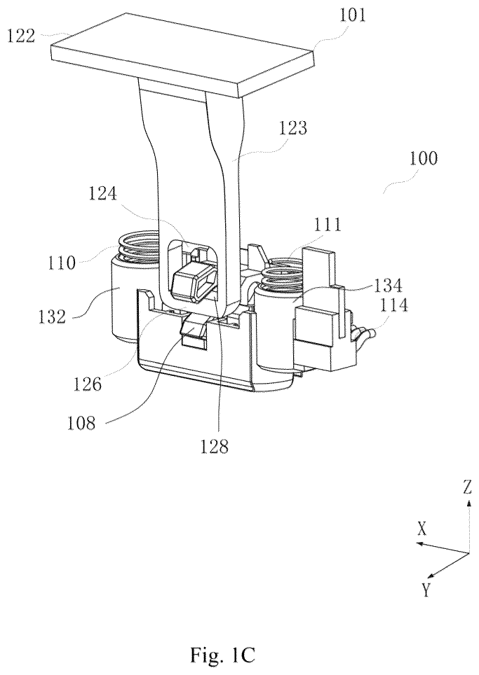

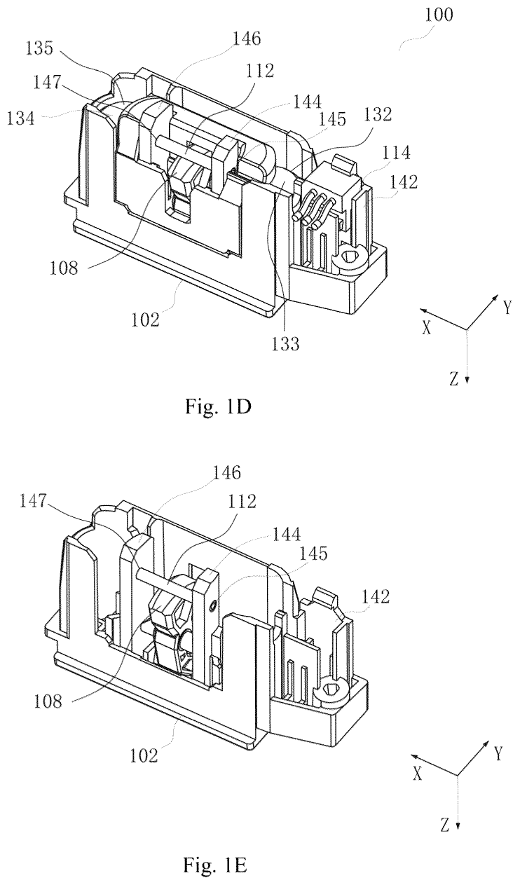

It should be noted that, for ease of description and observation, FIG. 1A is taken as a reference below, a direction in which a door lock assembly 100 (a length direction of the door lock assembly) extends from right to left is defined as a forward direction of direction X, a direction in which a housing 102 extends from rear to front is defined as a forward direction of direction Y (a width direction of the door lock assembly), and a direction in which a door hook 101 is pulled out from a housing 102 is defined as a forward direction of direction Z (a direction in which the housing 102 is directed from down to up). Since the embodiments of the present disclosure may be arranged in different orientations, the terms indicating directions X, Y and Z are merely illustrative and should not be considered as limitations.

FIGS. 1A-1F are schematic views of the door lock assembly 100 of the present disclosure viewed from respective perspectives. FIG. 1A is a perspective view of a door lock assembly of the present disclosure, with the door hook in an non-inserted status; FIG. 1B shows more components inside the housing 102 by concealing the housing 102 in FIG. 1A; FIG. 1C is a perspective view of the door lock assembly shown in FIG. 1B after the door hook is inserted; FIG. 1D is a perspective view of the door lock assembly of the present disclosure from a bottom perspective; FIG. 1E conceals some components in FIG. 1D, only shows the housing, a pin shaft and a rotating wheel to more clearly illustrate an assembly relationship between the pin shaft and the housing and a cooperation relationship between the pin shaft and the rotating wheel; FIG. 1F is an exploded view of the door lock assembly of the present disclosure.

As shown in FIGS. 1A-1C, the door lock assembly 100 includes a housing 102, and a movable component and the rotating wheel 108 that are accommodated in the housing 102, where the movable component may be a rotating wheel seat 104 that can be accommodated in the housing 102 and reciprocates relative to the housing 102 in the direction Z. The rotating wheel seat 104 has an upper movement limit position and a lower movement limit position in a reciprocation stroke thereof, the upper movement limit position of the rotating wheel seat 104 corresponds to an open position or an unclosed position of a door, and the lower movement limit position of the rotating wheel seat 104 corresponds to a closed position of the door. As shown in FIG. 1A, a door hook receiving hole 182 is provided in an upper surface of the housing 102 for accommodating the door hook 101 mounted on the door of an electrical apparatus. In the process of inserting the door hook 101 into the housing 102 through the door hook receiving hole 182 in the housing 102, the door hook 101 can engage with the rotating wheel 108 inside the door lock assembly 100, and when the door hook 101 is locked by the rotating wheel 108, the door of the electrical apparatus is locked accordingly.

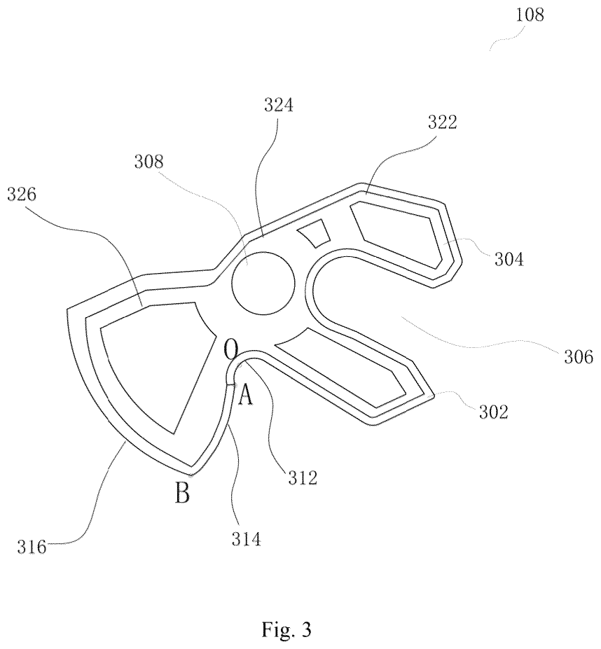

The door hook 101 includes a door hook base 122 and a door hook striker 123, where the door hook base 122 is mounted on the door of the electrical apparatus, a door hook cavity 124 and a door hook head 126 are arranged at an end of the door hook striker 123, and the door hook head 126 defines a lower side wall of the door hook cavity 124 and comprises a door hook head inner side surface 128. In the process of inserting the door hook 101 into the housing 102, the door hook head 126 can push the rotating wheel 108 to rotate about a rotating wheel rotating shaft 308 (see the rotating wheel rotating shaft 308 in FIG. 3), and the rotating wheel 108 can engage with the door hook cavity 124 during rotation. In the process of pulling the door hook 101 from the interior of the housing 102, the door hook head inner side surface 128 can pull the rotating wheel 108 to rotate in an opposite direction and causes the rotating wheel 108 to be gradually disengaged from the door hook cavity 124. When the door is in a closed status, a body part of the door hook striker 123 remains inside the housing 102, and the door hook cavity 124 of the door hook 101 is caught and locked by the rotating wheel 108, such that the door hook 101 and the door are locked and cannot move.

As shown in FIGS. 1B and 1C, the rotating wheel 108 is rotatably mounted on the rotating wheel seat 104, such that the rotating wheel 108 can reciprocally swing in the rotating wheel seat 104. Specifically, rotating wheel receiving portions 152, 153 are provided on the rotating wheel seat 104 for mounting the rotating wheel rotating shaft 308 of the rotating wheel 108, such that the rotating wheel 108 can be fixed on the rotating wheel seat 104 and is rotatable relative to the rotating wheel seat 104. A direction in which the rotating wheel rotating shaft 308 of the rotating wheel 108 extends is perpendicular or substantially perpendicular to the direction of reciprocating movement of the rotating wheel seat 104. The rotating wheel 108 has an upper swing limit position and a lower swing limit position in its swing range, where the upper swing limit position of the rotating wheel 108 corresponds to the upper movement limit position of the rotating wheel seat 104 and the open position or the unclosed position of the door, and the lower swing limit position of the rotating wheel 108 corresponds to the lower movement limit position of the rotating wheel seat 104 and the closed position of the door.

With continued reference to FIGS. 1B and 1C, the door lock assembly 100 further includes two bias springs 110, 111 arranged on the rotating wheel seat 104. Barrel-shaped bias spring accommodating cavities 132, 134 are provided respectively on the left side and the right side of the rotating wheel seat 104 in the direction X, and each of the bias spring accommodating cavities 132, 134 is configured to accommodate one of the bias springs. Inner diameters of the bias spring accommodating cavities 132, 134 are slightly greater than the outer diameters of the bias springs 110, 111, such that the bias springs will not be subjected to bending deformation deviating from a compression direction when they are compressed in the barrel-shaped accommodating cavities. One end of each bias spring abuts against the bottom of the bias spring accommodating cavities 132, 134, and the other end abuts against an inner surface of an upper wall of the housing 102. When the rotating wheel seat 104 moves close to the housing 102 in the direction Z, the bias springs 110, 111 are compressed, such that the bias springs 110, 111 can apply a biasing force to the rotating wheel seat 104 in a direction opposite to a movement direction of the rotating wheel seat 104, and thus the rotating wheel seat 104 has tendency to move away from the housing 102. In the embodiment of the present disclosure, the rotating wheel seat 104 moves close to the housing 102 during opening the door, and the bias springs are gradually compressed to store elastic potential energy; and during closing the door, the rotating wheel seat 104 moves away from the housing 102, and the bias springs gradually spring back from a compressed status to an initial status.

For those of ordinary skills in the art, only one barrel-shaped accommodating cavity may be provided on the rotating wheel seat 104, and a corresponding door lock assembly 100 includes only one bias spring, or more than two barrel-shaped accommodating cavities are provided on the rotating wheel seat 104, and each barrel-shaped accommodating cavity is configured to accommodate one bias spring, as long as the rotating wheel seat 104 can be subjected to the biasing forces of the bias springs when moving close to the housing 102 in the direction Z.

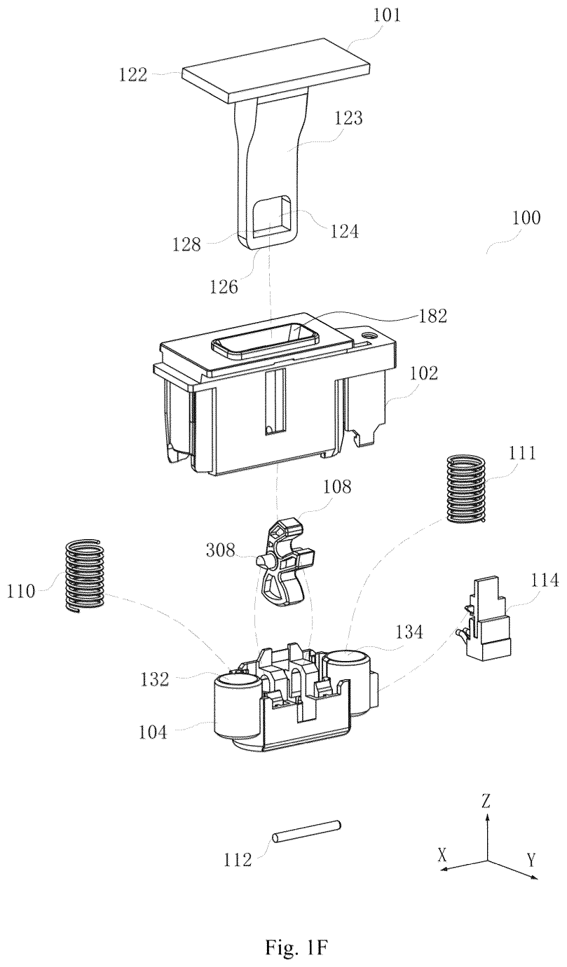

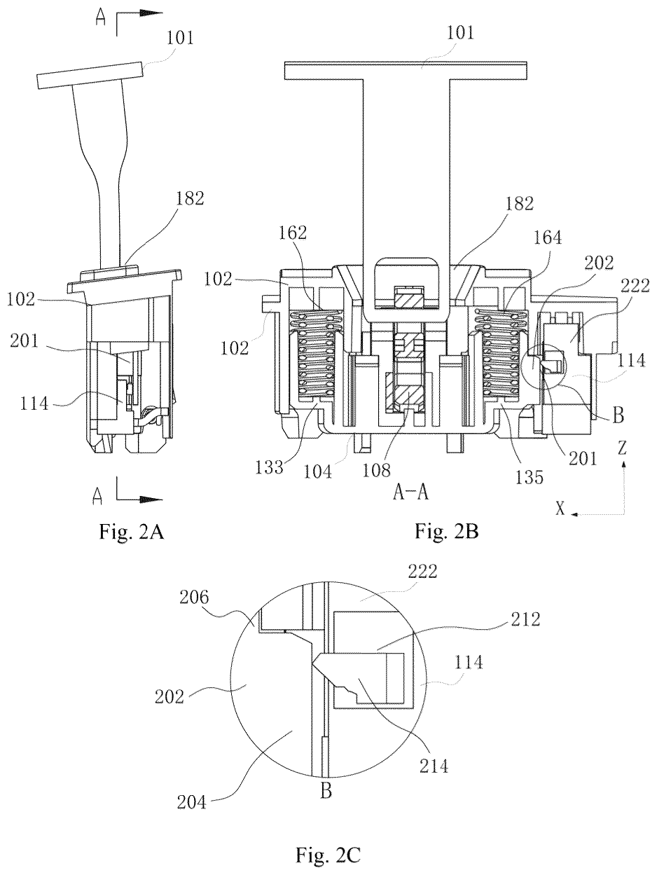

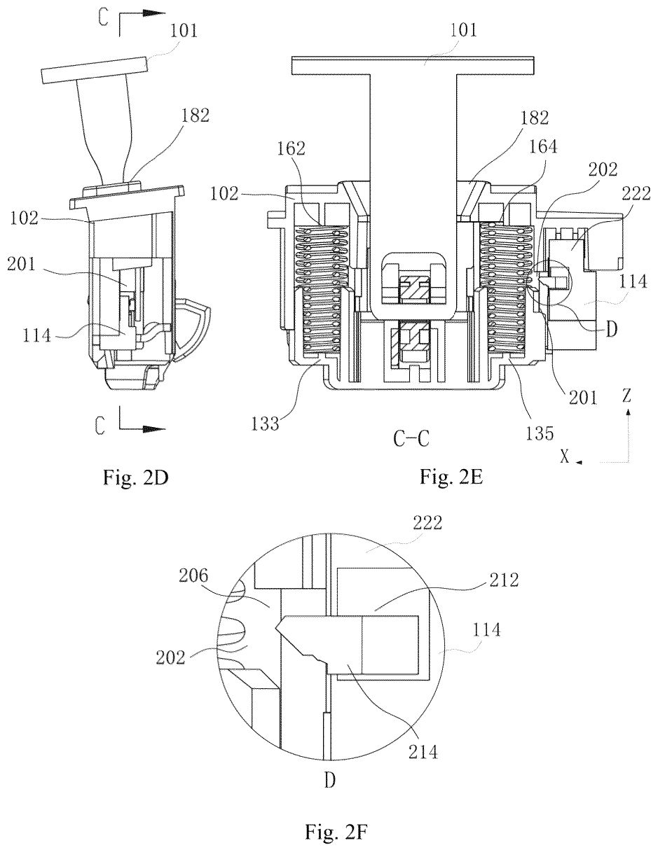

With continued reference to FIGS. 1B and 1C, the door lock assembly 100 further includes a door status signal assembly 114, where the door status signal assembly 114 is arranged close to the rotating wheel seat 104 in the direction X, that is, the door status signal assembly 114 is arranged on one side of the rotating wheel seat 104 in the length direction and configured to generate a door status indication signal in order to indicate a position where the door is located. The door status signal assembly 114 has a trigger switch or micro-switch 212 (see FIGS. 2A-2F). The trigger switch 212 of the door status signal assembly 114 gradually disengages with a triggering structure of the rotating wheel seat 104 (see details in FIGS. 2A-2F) during closing the door, and the trigger switch 212 of the door status signal assembly 114 can be triggered by the triggering structure of the rotating wheel seat 104 during opening the door.

FIG. 1D is a perspective view of the door lock assembly 100 of the present disclosure from a bottom perspective, and FIG. 1E conceals some components in FIG. 1D and only shows the housing 102, a pin shaft 112 and the rotating wheel 108 to more clearly illustrate an assembly relationship between the pin shaft 112 and the housing 102 and a cooperation relationship between the pin shaft 112 and the rotating wheel 108.

As shown in FIG. 1D, the door lock assembly 100 further includes the pin shaft 112. In the housing 102, left and right pin shaft mounting portions 144, 146 extend in a negative direction of the direction Z, each pin shaft mounting portion 144, 146 has a corresponding pin shaft mounting hole 145, 147 for securing the pin shaft 112, so as to allow the mounted pin shaft 112 to extend in the length (direction X) of the rotating wheel seat 104. The housing 102 has a door status signal assembly accommodating portion 142 configured to accommodate the door status signal assembly 114, such that the door status signal assembly 114 can be fixedly mounted on the housing 102.

Still as shown in FIG. 1D, the bias spring accommodating cavities 132, 134 of the rotating wheel seat 104 have accommodating cavity abutting walls 133, 135 (outer side surfaces of accommodating cavity bottom abutting walls are shown in the figure and are also shown in FIGS. 2B and 2E), such that one end of each of the bias springs 110, 111 accommodated in the bias spring accommodating cavities 132, 134 can abut against a corresponding one of the accommodating cavity abutting walls 133, 135. Bias spring abutting surfaces 162, 164 (see FIGS. 2B and 2E) are further correspondingly provided on an inner side of the housing 102, such that the other ends of the bias springs 110, 111 accommodated in the bias spring accommodating cavities 132, 134 can abut against the bias spring abutting surfaces 162, 164. Therefore, the compression of the bias springs 110, 111 are limited to the range between the accommodating cavity abutting walls 133, 135 of the rotating wheel seat 104 and the bias spring abutting surfaces 162, 164 of the housing 102, which are arranged opposite each other. Cavity walls of the barrel-shaped bias spring accommodating cavities 132, 134 can limit the bending deformations of the bias springs 110, 111 deviating from the compression direction, such that the bias springs 110, 111 can generate a springback force in proportion to a compression displacement during the compression, and the springback force acts on the accommodating cavity abutting walls 133, 135 of the bias spring accommodating cavities 132, 134, thus generating a biasing force for the rotating wheel seat 104 and the rotating wheel 108. Since the bias springs generate the stable biasing force, compared with a rotating wheel in the prior art, the movement of the rotating wheel seat 104 and the rotating wheel 108 inside the housing 102 will be smoother, so that the overall hand feeling of a door-opening/closing action is smoother.

As shown in FIG. 1E, the pin shaft 112 remains abutting against a cam surface of the rotating wheel 108, and the pin shaft 112 can always contact the rotating wheel 108 under the action of the bias springs 110, 111. Since the cam surface of the rotating wheel 108 has different rotation radii, the rotating wheel 108 can, during the rotation, abut against the pin shaft 112 at the different rotation radii by means of the cam surface of the rotating wheel 108 such that the rotating wheel 108, together with the rotating wheel rotating shaft 308 can move relative to the pin shaft 112. As described above, the rotating shaft of the rotating wheel 108 is fixedly mounted on the rotating wheel seat 104, so that the movement of the rotating wheel 108 allows the rotating wheel seat 104 to move with the rotating wheel 108 relative to the pin shaft 112. Since the movement of the rotating wheel seat 104 inside the housing 102 is limited in the direction Z, the rotating wheel 108 can, during the reciprocating swing movement, allow the rotating wheel seat 104 to reciprocate relative to the housing 102 in the direction Z.

FIG. 1F is an exploded view of the door lock assembly of the present disclosure to illustrate a mounting relationship and a positional relationship between various components of the door lock assembly 100.

As shown in FIG. 1F, the door hook 101 mounted on the door of the electric apparatus may be inserted into the housing 102 through the door hook receiving hole 182 of the upper surface of the housing 102, such that the door hook engages with the rotating wheel 108 arranged inside the housing 102. When inserted into the housing 102, the door hook 101 can impact the rotating wheel 108 to make the rotating wheel swing downward, and when pulled out from the housing 102, the door hook 101 can pull the rotating wheel 108 to make the rotating wheel swing upward. The rotating wheel 108 is rotatably mounted on the rotating wheel seat 104 arranged inside the housing 102 by means of the rotating wheel rotating shaft 308, such that the rotating wheel 108 can swing back and forth in the rotating wheel seat 104, and no movement, except rotation, of the rotating wheel 108 relative to the rotating wheel seat 104 can occur. The rotating wheel 108 and the rotating wheel seat 104 can move simultaneously relative to the housing 102 in the direction Z during the movement of the rotating wheel seat 104 relative to the housing 102 in the direction Z. During the movement of the rotating wheel seat 104 relative to the housing 102, the door status signal assembly 114, which is also arranged inside the housing 102, can be actuated by the triggering structure to turn on or off the door status signal assembly 114, thereby generating different door status indication signals. The two bias springs 110, 111 are accommodated in the bias spring accommodating cavities 132, 134 of the rotating wheel seat 104 and abut upward against the inner wall of the housing 102, so the bias springs 110, 111 trend to move the rotating wheel seat 104 away from the housing 102, that is, trend to move downward relative to the housing 102 in the negative direction of the direction Z. Since the cam surface (see FIG. 3 for details) of the rotating wheel 108 mounted on the rotating wheel seat 104 facing one side of the door hook 101 is arranged on an upper side of the pin shaft 112, the cam surface of the rotating wheel 108 can always contact the pin shaft 112 under the action of the biasing force of the bias springs 110, 111.

FIGS. 2A-2F show schematic views of the door lock assembly from other perspectives to illustrate a cooperation relationship between the triggering structure of the rotating wheel seat 104 and the door status signal assembly 114. FIG. 2A is a side view of the door lock assembly of the present disclosure in the unclosed status, FIG. 2B is a cross-sectional view of FIG. 2A taken along sectional line A-A, and FIG. 2C is a partial enlarged view B of FIG. 2B; FIG. 2D is a side view of the door lock assembly of the present disclosure in the closed status, FIG. 2E is a cross-sectional view of FIG. 2D taken along sectional line C-C, and FIG. 2F is a partial enlarged view D of FIG. 2E.

As shown in FIGS. 2A-2F, one side of the rotating wheel seat 104 in the length direction (the negative direction of the direction X in FIG. 2B) has a side surface 201, the triggering structure 202 is arranged on the side surface 201 and comprises a stepped structure, which includes a step protruding portion 204 and a step recessing portion 206 sequentially adjacent to each other in the direction Z, where the step protruding portion 204 is provided under the step recessing portion 206. The door status signal assembly 114 is mounted toward the side surface 201 of the rotating wheel seat 104 in the length direction of the rotating wheel seat 104 and includes the trigger switch 212. The trigger switch 212 has a switch protruding structure 214 arranged toward the step structure. The switch protruding structure 214 is in an extended position when it is not subjected to force, and is moved to a retracted position once this structure is subjected to a press force.

During the reciprocating movement of the rotating wheel seat 104 in the direction Z, when the step protruding portion 204 of the step structure moves to a position coinciding with the switch protruding structure 214 of the trigger switch 212 (see FIG. 2C for details), the step protruding portion 204 comes into contact with and presses the switch protruding structure 214 to bring the switch protruding structure 214 in the retracted position, such that the door status signal assembly 114 generates a first status signal of the door. When the step recessing portion 206 of the step structure moves to a position coinciding with the switch protruding structure 214 of the trigger switch 212 (see FIG. 2F for details), the step protruding structure 204 no longer contacts with the switch protruding structure 214 and stops pressing the switch protruding structure 214 to bring the switch protruding structure 214 in the extended position, such that the door status signal assembly 114 generates a second status signal of the door.

More specifically, when the door hook 101 is not inserted or has just been inserted into the door hook receiving hole 182 of the housing 102, the rotating wheel seat 104 is in an upper position in the housing 102, the step protruding portion 204 is at a position coinciding with the switch protruding structure 214 (see FIGS. 2B and 2C for details), the switch protruding structure 214 is pressed to the retracted position, and the door status signal assembly 114 generates a signal indicating that the door is not closed (the first status signal); and when inserted into the housing 102 from the door hook receiving hole 182 by a depth through the door hook receiving hole 182, the door hook 101 moves downward, the step recessing portion 206 above the step protruding portion 204 moves to a position coinciding with the switch protruding structure 214 (see FIGS. 2E and 2F for details), the step protruding portion 204 moves until the step protruding portion no longer contacts with the switch protruding structure 214, the switch protruding structure 214 is released and thus returns to the extended position, and thus the door status signal assembly 114 generates a signal indicating that the door is closed (a second status signal).

In the embodiment of the present disclosure, the door status signal assembly 114 further includes a circuit board 222, the circuit board 222 being fixedly mounted on the door lock assembly 100. The trigger switch 212 is mounted on the circuit board 222, and the switch protruding structure 214 of the trigger switch 212 extends out of the circuit board 222 toward the triggering structure 202 of the rotating wheel seat 104. The circuit board 222 is provided with a circuit (not shown) that generates a signal indicating that the door is closed or not closed.

For those of ordinary skill in the art, upper and lower positional relationship between the step protruding portion 204 and the step recessing portion 206 may also be adjusted, and by changing circuit settings, the door status signal assembly 114 generates the signal indicating that the door is closed when the switch protruding structure 214 is pressed to the retracted position, and the door status signal assembly 114 generates the signal indicating that the door is not closed when the switch protruding structure 214 is released to the extended position, as long as the door status signal assembly 114 generates corresponding door status signals as the rotating wheel seat 104 is in the different movement positions.

FIG. 3 is a side view of the rotating wheel 108 to illustrate a specific structure of the rotating wheel 108.

As shown in FIG. 3, the rotating wheel 108 includes a rotating wheel lock hook 322 located at a rotating wheel head, a rotating wheel middle section 324, and a rotating wheel tail section 326, the rotating wheel middle section 324 being provided with the rotating wheel rotating shaft 308, and the rotating wheel lock hook 322 being provided with a lower lock hook 302, an upper lock hook 304 and a lock hook accommodating cavity 306. When the door hook 101 is inserted into the housing 102, the door hook head 126 of the door hook 101 can impinge the lower lock hook 302 of the rotating wheel 108 to cause the rotating wheel 108 to swing downward (in a clockwise direction in FIG. 3); when the door hook 101 is pulled out from the housing 102, a door hook head inner side surface 128 of the door hook 101 can pull the upper lock hook 304 of the rotating wheel 108 to cause the rotating wheel to swing upward (in a counterclockwise direction in FIG. 3); and when the door is in the closed status, the door hook 101 is held inside the door lock assembly 100, and the door hook 101 is limited in the lock hook accommodating cavity 306 of the rotating wheel 108, such that the door hook 101 is locked and cannot move.

The rotating wheel tail section 326 has a cam structure, and an outer edge of the cam structure has different rotation radii. The cam structure may abut against the pin shaft 112 such that when the rotating wheel 108 swings back and forth in the rotating wheel seat 104, the rotating wheel 108 can reciprocate inside the housing 102 relative to the pin shaft 112 and drive the rotating wheel seat 104 to reciprocate therewith. During the reciprocating movement of the rotating wheel seat 104 inside the housing 102, the bias springs 110, 111 are compressed or spring back in the bias spring accommodating cavities 132, 134 of the rotating wheel seat 104, so as to apply or remove the biasing force to the rotating wheel seat 104.

With continued reference to FIG. 3, the cam structure of the rotating wheel 108 has an inner side surface 312, 314 and an outer side surface 316, the inner side surface including a circular groove 312 and an ascending slope surface 314, and the outer side surface 316 being a descending slope surface 316. The circular groove 312 and the ascending slope surface 314 meet at point A, and the ascending slope surface 314 and the descending slope surface 316 meet at point B. An inner diameter of the circular groove 312 is substantially the same as the outer diameter of the pin shaft 112, such that the pin shaft 112 can be exactly engaged in the circular groove 312, and a position where the pin shaft 112 is engaged in the circular groove 312 corresponds to a limit position for the downward swing of the rotating wheel 108, that is, a stable position in which the door is in the closed status. When the door is opened from the closed position, the door hook 101 pulls the rotating wheel 108 upward, and when the rotating wheel 108 trends to swing upward, an acting force resulting from the pin shaft 112 abutting against the circular groove 312 occurs at point O of the circular groove 312. When the door is opened, the rotating wheel 108 swings upward to the limit position, and the pin shaft 112 abuts against the descending slope surface 316 of the rotating wheel 108, that is, the rotating wheel 108 is in a stable position where the door is in an open status.

If the rotating wheel 108 and the pin shaft 112 abuts against the descending slope surface 316 without an external force, an abutment force resulting from the abutment of the rotating wheel 108 in this abutting position is directed to the center of the rotating wheel rotating shaft 308 of the rotating wheel 108 and thus dose not generate any torque to the rotating wheel 108, and meanwhile the abutment force can counteract the biasing force applied by the bias springs 110, 111 to the rotating wheel 108 and the rotating wheel seat 104, so that the rotating wheel 108 and the rotating wheel seat 104 remain stationary relative to the housing 102 without movement; if the rotating wheel 108 and the pin shaft 112 abut against the circular groove 312 or the ascending slope surface 314, the abutment force resulting from the abutment of the rotating wheel 108 in the abutting position is directed to the left side relative to the center of the rotating wheel rotating shaft 308 of the rotating wheel 108, the abutment force causes a downward swing torque to the rotating wheel 108, and therefore the abutment force causes the rotating wheel 108 to swing downward. Upon the swing of the rotating wheel 108, the abutment of the rotating wheel 108 against the pin shaft 112 allows, under the action of the abutment force, the rotating wheel 108 and the rotating wheel seat 104 to move relative to the housing 102 in the negative direction of the direction Z, and ultimately the rotating wheel 108 drives the door hook 101 to pull the door to the closed position.

For ease of description, the descending slope surface 316 of the rotating wheel 108 is referred to as a rotating wheel retaining side, and the circular groove 312 or the ascending slope surface 314 of the rotating wheel 108 is referred to as a rotating wheel abutting side hereinafter.

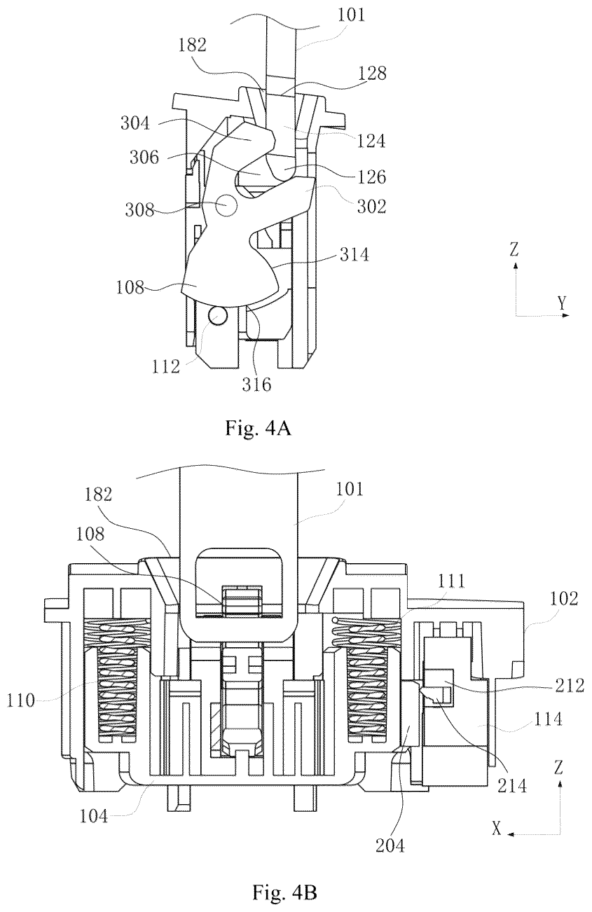

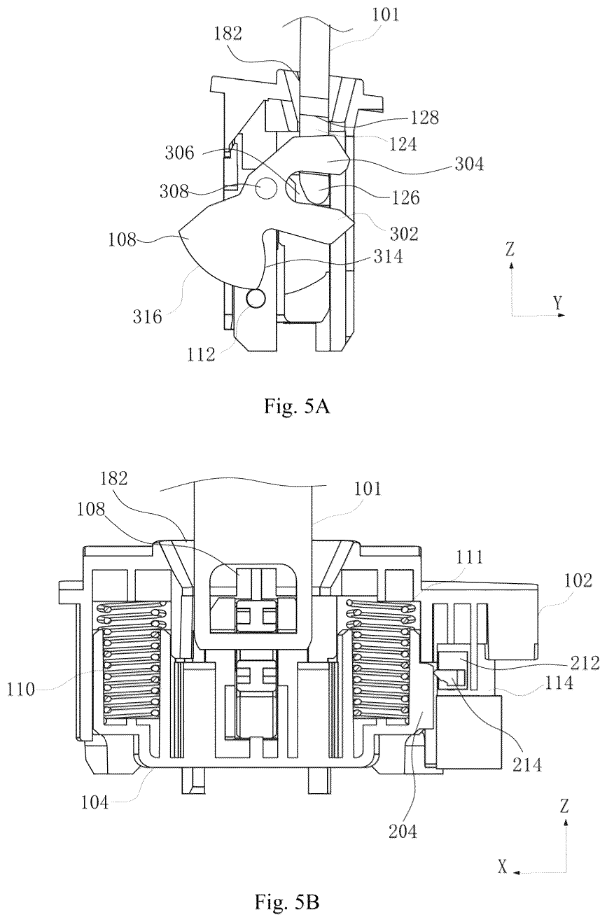

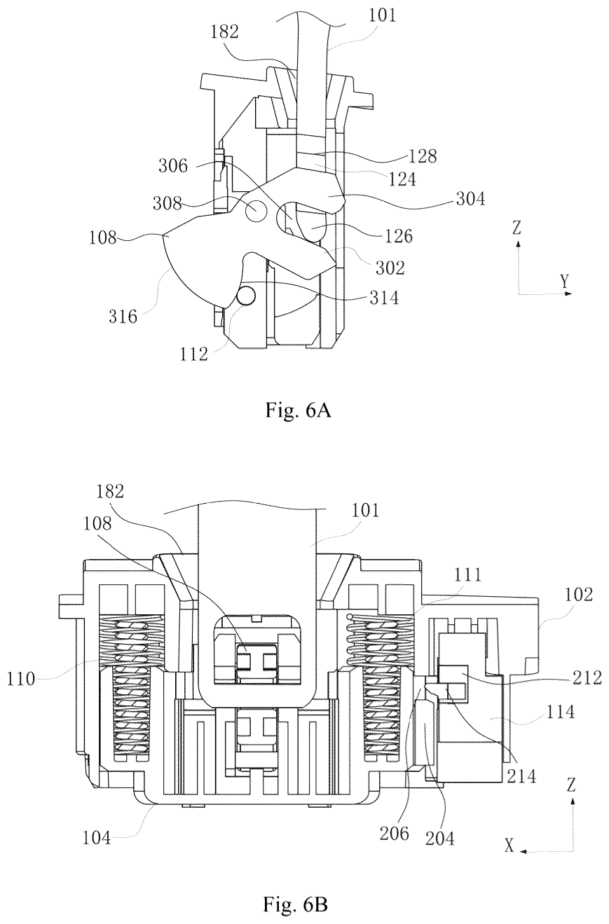

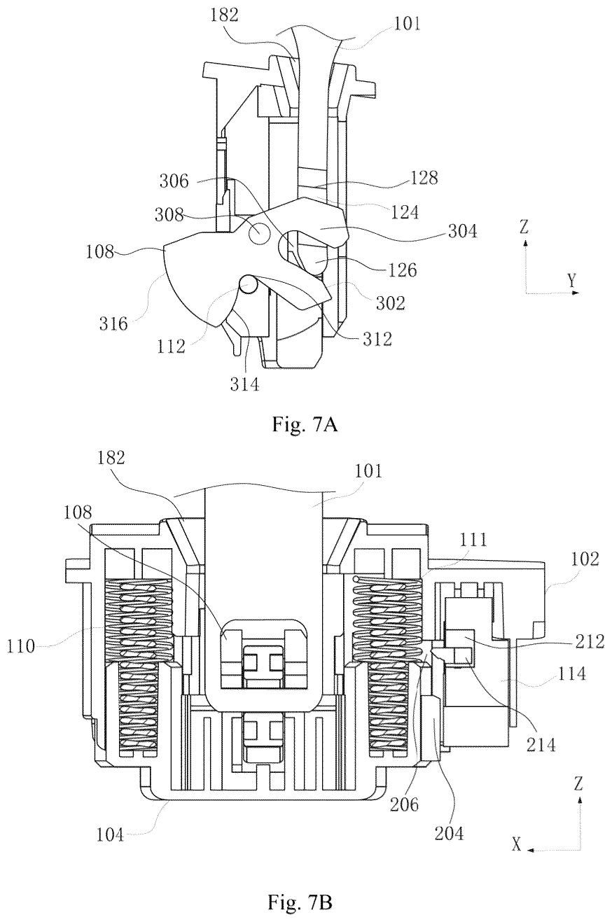

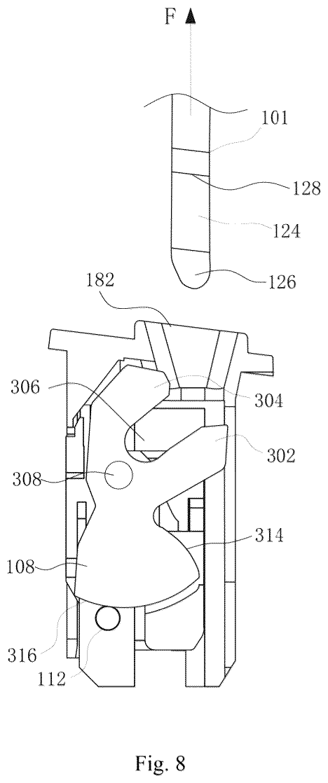

FIGS. 4A-8 show schematic movement views of internal components of the door lock assembly 100 during closing and opening the door, and also show different trigger statuses of the door status signal assembly 114. For ease of viewing, only the door hook striker 123 of the door hook 101 is shown in the figures, and the door hook base 122 is omitted. FIG. 4A is an interior side view when the door hook is inserted into the door hook receiving hole and just comes into contact with the rotating wheel, and FIG. 4B is an interior view of the door hook in an inserted status shown in FIG. 4A from another perspective; FIG. 5A is an interior side view of the door hook inserted into the door hook receiving hole by a first depth, and FIG. 5B is an interior view of the door hook in the inserted status in FIG. 5A from another perspective; FIG. 6A is an interior side view of the door hook inserted into the door hook receiving hole by a second depth, and FIG. 6B is an interior view of the door hook in the inserted status shown in FIG. 6A from another perspective; FIG. 7A is an interior side view of the door hook completely inserted into the door hook receiving hole, and FIG. 7B is an interior view of the door hook in the inserted status shown in FIG. 7A from another perspective; and FIG. 8 is an interior side view of the door hook completely pulled out from the door hook receiving hole.

As shown in FIGS. 4A and 4B, the door hook 101 downward passes through the door hook receiving hole 182, the door hook head 126 just comes into contact with and pushes the lower lock hook 302 of the rotating wheel 108, the rotating wheel 108 trends to swing downward, and the upper lock hook 304 of the rotating wheel 108 trends to extend into the door hook cavity 124. The step protruding portion 204 of the rotating wheel seat 104 is at a position coinciding with the switch protruding structure 214 of the trigger switch 212, the switch protruding structure 214 is pressed to the retracted position, and thus the door status signal assembly 114 generates the signal indicating that the door is not closed. At this point, the rotating wheel retaining side 316 of the rotating wheel 108 abuts against the pin shaft 112, and the resulting abutment force counteracts the biasing force applied by the bias springs 110, 111 to the rotating wheel 108 and the rotating wheel seat 104, and a downward insertion force of the door hook 101 provides a rotation torque and closing force to the rotating wheel 108.

As shown in FIGS. 5A and 5B, as the door hook 101 is further inserted downward into the door hook receiving hole 182, the door hook head 126 continues to downward push the lower lock hook 302 of the rotating wheel 108 to swing the rotating wheel 108 downward, and the upper lock hook 304 of the rotating wheel 108 extends into the door hook cavity 124 and thus engage with the door hook 101. The step protruding portion 204 of the rotating wheel seat 104 is still at a position coinciding with the switch protruding structure 214 of the trigger switch 212, the switch protruding structure 214 is pressed to the retracted position, and thus the door status signal assembly 114 generates the signal indicating that the door is not closed. Due to the downward swing of the rotating wheel 108, the position where the rotating wheel abuts against the pin shaft 112 undergoes gradual transition from the rotating wheel retaining side 316 to the rotating wheel abutting side 314, the resulting abutment force can still counteract the biasing force applied by the bias springs 110, 111 to the rotating wheel 108 and the rotating wheel seat 104, and at this point, the downward insertion force of the door hook 101 provides the rotation torque and the closing force to the rotating wheel 108.

As shown in FIGS. 6A and 6B, as the door hook 101 is further inserted downward into the door hook receiving hole 182, the door hook head 126 continues to downward push the lower door hook 302 of the rotating wheel 108 to cause the rotating wheel 108 to swing downward. The upper lock hook 304 of the rotating wheel 108 remains in the door hook cavity 124 and engages with the door hook 101. The step recessing portion 206 of the rotating wheel seat 104 moves to coincide with the switch protruding structure 214, the step protruding portion 204 moves until the step protruding portion no longer contacts with the switch protruding structure 214, the switch protruding structure 214 is released and returns to the extended position, and thus the door status signal assembly 114 generates the signal indicating that the door is closed. Due to the downward swing of the rotating wheel 108, the position where the rotating wheel abuts against the pin shaft 112 undergoes the transition from the rotating wheel retaining side 316 to the rotating wheel abutting side 314, and the resulting abutment force cannot continue counteracting the biasing force applied by the bias springs 110, 111 to the rotating wheel 108 and the rotating wheel seat 104. Therefore, the biasing force applied by the bias springs 110, 111 to the rotating wheel 108 and the rotating wheel seat 104 can push the rotating wheel seat 104 to move the rotating wheel 108 downward, causing the rotating wheel 108 to further swing downward and thus pulling the door hook 101 to move downward. At this point, the rotating wheel 108 and the rotating wheel seat 104 continue moving downward under the action of the biasing force of the bias springs 110, 111 without an external force.

Referring to FIGS. 7A and 7B, when the rotating wheel 108 downward swings to the lower swing limit position (i.e., the pin shaft 112 abuts in the circular groove 312 of the rotating wheel abutting side), the rotating wheel seat 104 moves to the lower movement limit position, and the door hook 101 is inserted downward by a maximum depth, that is, a position where the door hook is completely inserted into the door hook receiving hole 182. The step recessing portion 206 of the rotating wheel seat 104 remains coincident with the switch protruding structure 214, the switch protruding structure 214 remains in the extended position, and the door status signal assembly 114 continuously generates the signal indicating the door is closed. At this point, the door is in the completely closed status, and the upper lock hook 304 of the rotating wheel 108 remains in the door hook cavity 124 and engages with the door hook 101. Under the action of the biasing force of the bias springs 110, 111, the door remains in the completely closed status and locked all the times as long as there is no external force counteracting the biasing force.

Referring to FIG. 8, if it is required to open the door when the door is in the closed status, a continuous upward pull force F needs to be applied to the door, such that the door hook head 126 of the door hook 101 pulls the upper lock hook 304 of the rotating wheel 108 to swing the rotating wheel 108 upward. During the upward swing of the rotating wheel 108, the upper lock hook 304 of the rotating wheel 108 gradually exits the door hook cavity 124 and is disengaged from the door hook 101, and the position where the rotating wheel 108 abuts against the pin shaft 112 also undergoes the transition from the rotating wheel abutting side 314 to the rotating wheel retaining side 316. When the door hook 101 is completely disengaged from the upper lock hook 304 of the rotating wheel 108, the rotating wheel seat 104 moves to the upper movement limit position, and the rotating wheel 108 swings upward to the upper swing limit position; in this position, the resulting abutment force at a position where the rotating wheel retaining side 316 abuts against the pin shaft 112 can counteract the biasing force applied by the bias springs 110, 111 to the rotating wheel 108 and the rotating wheel seat 104. Therefore, the rotating wheel 108 remains in a position where the rotating wheel is disengaged from the door hook 101 without any movement or swing, and the rotating wheel 108 can not be actuated to move downward and swing until the door hook 101 is inserted again.

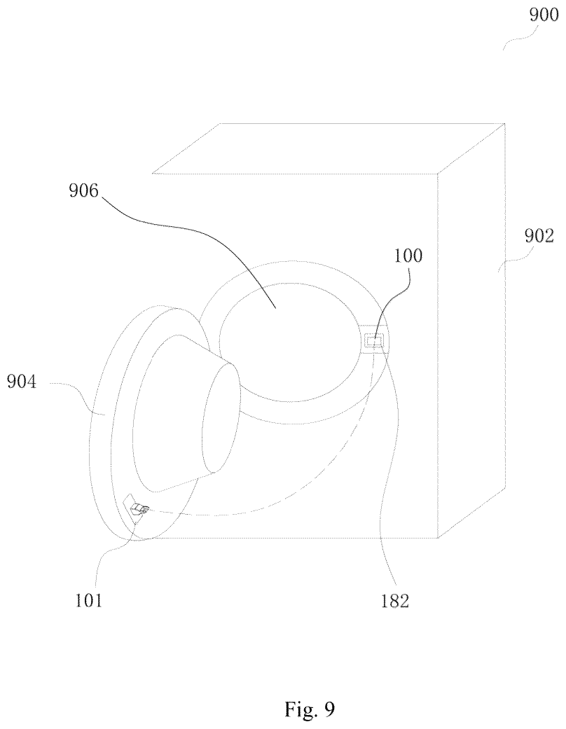

FIG. 9 is a schematic diagram of an electrical apparatus 900 using a door lock assembly 100 of the present disclosure in a door open position.

As shown in FIG. 9, the electrical apparatus 900 may be a dryer, which is provided with a dryer body 902, a door 904, a cavity 906 and the door lock assembly 100, where the door hook 101 is arranged on an inner side of the door 904, and the door lock assembly 100 is arranged on the dryer body 902 at a position corresponding to the door hook 101. By closing the door 904, the door hook 101 can pass through the door hook receiving hole 182 to be engaged with a rotating wheel 108 inside the door lock assembly 100 to lock the door 904 by means of the movement process described above.

The dryer shown in FIG. 9 is merely exemplary, and the door lock assembly of the present disclosure may also be mounted on various types of electrical apparatuses each having a cavity and a door for closing the cavity, such as a washing machine, a dishwasher, and a microwave oven, and may also be mounted on other non-electrical apparatuses.

The present disclosure aims to at least partially solve the technical problems mentioned in this description.

The door lock assembly of the present disclosure can at least achieve the following beneficial technical effects.

First, in the door lock assembly of the present disclosure, the door status signal assembly is arranged toward the side surface of the rotating wheel seat in the length direction, so that the door lock assembly has a smaller dimension in a width or thickness direction, and the door lock assembly can be manufactured more compact.

Second, since the door lock assembly of the present disclosure is thin in the thickness direction, the door lock assembly may be interchanged in the left and right directions when mounted to the electrical apparatus, and the door lock assembly can also be mounted from a front side of the electrical apparatus without disassembling the electrical apparatus.

Third, the door lock assembly of the present disclosure uses the door status signal assembly provided with the circuit board, and the trigger switch or micro-switch is directly connected to the circuit board, so that the overall size of the door status signal assembly is reduced, and the door lock assembly is more compact in structure; Also, the door lock assembly of the present disclosure does not use a reed switch for generating a door status signal, so that manufacturing costs are lower.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

1. A door lock assembly for locking a door of an electrical apparatus, comprising:
a movable component configured to reciprocate in a first direction and a second direction, wherein the first direction is opposite to the second direction, the movable component has a side surface in a length direction, and the movable component is provided with a triggering structure on the side surface; and
a door status signal assembly arranged toward the side surface of the movable component and configured to generate a door status indication signal;
wherein the triggering structure is configured to activate the door status signal assembly during the reciprocating movement of the movable component, so that the door status signal assembly generates the door status indication signal.

2. The door lock assembly of claim 1, wherein:
the movable component has a first position and a second position in a movement stroke, and the movable component is configured to reciprocate between the first position and the second position in the first direction and the second direction.

3. The door lock assembly of claim 2, wherein:
the movable component is configured to be movable under actuation of a door hook of the door, wherein the door hook is movable in the first direction or the second direction to drive the movable component to move in the first direction or the second direction.

4. The door lock assembly of claim 3, wherein:
the door lock assembly is provided with a door hook receiving hole, the door hook receiving hole configured to accommodate the door hook;
wherein the door hook is configured to actuate the movable component to move towards the first direction when the door hook is inserted into the door hook receiving hole; and
wherein the door hook is configured to actuate the movable component to move towards the second direction when the door hook is pulled out from the door hook receiving hole.

5. The door lock assembly of claim 4, wherein:
the movable component is in the first position when the door hook is completely inserted into the door hook receiving hole; and
the movable component is in the second position when the door hook is completely pulled out from the door hook receiving hole.

6. The door lock assembly of claim 1, wherein:
the triggering structure is provided with a step structure, the step structure comprising a step protruding portion and a step recessing portion;
the door status signal assembly comprises a switch, the switch provided with a switch protruding structure, and the switch protruding structure arranged toward the step structure;
wherein the step protruding portion is in contact with the switch protruding structure when the step protruding portion of the step structure moves to a position coinciding with the switch protruding structure of the switch during the reciprocating movement of the movable component in the first direction and the second direction, so that the door status signal assembly generates a first door status signal of the door; and the step protruding portion disengages from the switch protruding structure when the step recessing portion of the step structure moves to a position coinciding with the switch protruding structure of the switch, so that the door status signal assembly generates a second door status signal of the door.

7. The door lock assembly of claim 6, wherein:
the first door status signal indicates a closed state of the door, and the second door status signal indicates an unclosed state of the door; or
the first door status signal indicates an unclosed state of the door, and the second door status signal indicates a closed state of the door.

8. The door lock assembly of claim 7, wherein:
the door status signal assembly further comprises a circuit board, the switch being mounted on the circuit board, and the switch protruding structure of the switch being disposed to extend out of the circuit board toward the triggering structure of the movable component; and
wherein the circuit board is provided with a circuit for generating the first door status signal and the second door status signal.

9. The door lock assembly of claim 8, wherein:
the circuit board is fixedly mounted on the door lock assembly.

10. The door lock assembly of claim 2, wherein:
the first position corresponds to a closed position of the door, and the second position corresponds to an unclosed position of the door.

11. The door lock assembly of claim 4, further comprising:
a rotating wheel provided with a rotating wheel rotating shaft, and the rotating wheel rotating shaft being rotatably mounted on the movable component, such that the rotating wheel is rotatable on the movable component in a first rotational direction or a second rotational direction;
wherein a direction in which the rotating wheel rotating shaft extends is perpendicular or substantially perpendicular to the first direction or the second direction.

12. The door lock assembly of claim 11, further comprising:
a housing, wherein the movable component and the rotating wheel are configured to be movably accommodated within the housing;
a pin shaft fixedly mounted on the housing; and
wherein the rotating wheel has a rotating wheel abutting side, and the rotating wheel abutting side is configured to abut against the pin shaft, so that the rotating wheel rotating shaft is movable in the first direction or the second direction under the abutting action when the rotating wheel rotates in the first rotational direction or the second rotational direction in the movable component, so as to drive the movable component to move in the housing in the first direction or the second direction.

13. The door lock assembly of claim 12, wherein:
the door hook receiving hole is formed on a surface of the housing, and the door hook is configured to be movable through the door hook receiving hole so as to insert into the housing;
wherein the rotating wheel is driven to rotate in the first rotational direction or the second rotational direction about the rotating wheel rotating shaft when the door hook is inserted into or pulled out from the door hook receiving hole, so as to drive the movable component to move in the first direction or the second direction in the housing.

14. The door lock assembly of claim 13, wherein:
the rotating wheel is also provided with a rotating wheel lock hook and the rotating wheel lock hook is arranged on an opposite side of the rotating wheel with respect to the rotating wheel abutting side;
wherein the door hook is configured to abut against and engage with the rotating wheel lock hook when the door hook is inserted into the door hook receiving hole, so as to drive the rotating wheel to rotate in the first rotational direction, and the rotating wheel is rotatable in the first rotational direction to drive the movable component to move in the housing in the first direction under the abutting action between the rotating wheel abutting side and the pin shaft; and
wherein the door hook is gradually disengaged from the rotating wheel lock hook and drives the rotating wheel to rotate in the second rotational direction when the door hook is pulled out from the door hook receiving hole, and the rotating wheel is rotatable in the second rotational direction to drive the movable component to move in the housing in the second direction under the abutting action between the rotating wheel abutting side and the pin shaft.

15. The door lock assembly of claim 14, further comprising:
at least one bias spring abutted between the housing and the movable component so as to provide a biasing force for the movable component to move towards the first direction; and
wherein the at least one bias spring is configured to store biasing potential energy during movement of the movable component towards the second direction.

16. The door lock assembly of claim 15, wherein:
the movable component is a rotating wheel seat, the rotating wheel seat provided with at least one bias spring accommodating cavity for accommodating the at least one bias spring; and
a bias spring abutting surface is provided at an inner side of the housing for abutting against the at least one bias spring, so that the at least one bias spring is abutted between the bias spring abutting surface and an accommodating cavity abutting wall of the at least one bias spring accommodating cavity.

17. The door lock assembly of claim 16, wherein:
the rotating wheel also has a rotating wheel retaining side, the rotating wheel retaining side being configured to be able to abut against the pin shaft such that the rotating wheel is able to remain stable without movement relative to the housing when not actuated by the door hook;
wherein the rotating wheel retaining side is adjacent to the rotating wheel abutting side, and the rotating wheel is rotated to a position such that the rotating wheel retaining side abuts against the pin shaft when the movable component moves to the second position.

18. An electrical apparatus comprising a door lock assembly of claim 1.
